(19) United States
(12) Patent Application Publication
(10) Pub. No.: US 2006/0048595 A1
(43) Pub. Date: Mar. 9, 2006

(54) Bevel gear transmission

(76) Inventor: Manfred Obermeier, Wolfenbuttel (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/523,126

(22) PCT Filed: Jul. 25, 2003
(86) PCT No.: PCT/DE03/02532

§ 371 Date: Jan. 26, 2005

(30) Foreign Application Priority Data
Jul. 26, 2002 (DE) 102 34 331.4

(51) Int. Cl. F16H 1/14

(52) U.S. Cl. 74/417

(57) ABSTRACT

The invention relates to a bevel gear transmission having a housing (1), whose walls (2) are provided with at least two passage holes (3, 3′) for at least two bevel gears (4, 4′) that engage with one another with their gearings inside the transmission housing (1). At lest one of said bevel gears has a shaft (5) rotationally mounted in a bearing (22, 23) of a bearing casing (6), said shaft projecting from the transmission housing (1) through the passage hole (3), wherein the bearing casing (6) is fixed to the transmission housing (1). According to the invention, axial displacement of the bevel gear (4) can be exactly and reproducibly carried out due to the fact that a fixing part (9) that is configured separately from the bearing housing (6) is fixed to the transmission housing (1) said fixing part having an inner thread (13) that can be screwed with the outer thread of the bearing casing (6), that the relative angular position between the fixing part (9) and the bearing housing (6) can be fixed and that the bearing housing (6), when assembled with a cylindrical attachment (8), tightly fits into the corresponding passage hole (3) of the transmission housing (1), that is configured in the form of a guide.

The invention relates to a bevel gear transmission with a transmission housing, the walls of which are provided with at least two passage orifices for at least two bevel wheels which engage with their toothings one in the other inside the transmission housing and at least one of which has a shaft which is mounted rotatably in a bearing of a bearing housing and which projects out of the transmission housing through the passage orifice, the bearing housing being fastened to an outer face of the transmission housing.

Beveled gear transmissions of this type are required in numerous embodiments and sizes. For their functioning and service life, it is essential that the toothings of the bevel wheels engage one in the other exactly in the intended way. For this purpose, it is important that the bevel wheels, usually perpendicular to one another, are in an exact angular position, accurately in position with respect to the position of the axis of rotation and, in particular, accurately in position axially.

It is known to mount the bevel wheels with their axles in a bearing housing which is positioned exactly on the outer face of the transmission housing and is positioned by means of a flange and corresponding screw connections, so that the bevel wheel mounted by means of the bearing housing projects through the passage orifice into the interior of the transmission housing. The angular positioning and positioning with respect to the position of the axis of rotation are in this case carried out with sufficient accuracy. Problems arise with the manufacturing tolerances as regards the positioning of the bevel wheel axially with respect to the axis of rotation. Even slight deviations from the desired axial position of the bevel wheel lead either to excessive pressure between the meshing bevel wheels and consequently to a sluggish transmission and increased wear of the teeth or to play between the meshing teeth which leads, on the one hand, to the generation of noise and, on the other hand, likewise to increased wear. It is therefore customary, during the mounting of the bevel gear transmission, to work with tolerance plates which are introduced between the bearing housing and the transmission housing in order to adjust the axial position of the bevel wheel mounted in the bearing housing. The thicknesses of the tolerance plates are in this case different and amount to between 1/100 mm and 1/10 mm. The satisfactory mounting of a bevel gear transmission of this type therefore presupposes considerable experience, since, when the screws for fastening the bearing housing to the transmission housing are tightened, the axial position of the bevel wheels changes by a few 1/100 mm, and the person mounting the bevel gear transmission has to take this into account beforehand by estimation when the meshing bevel wheels are being held together. The result of this is that an exact and accurately reproducible mounting of the bevel gear transmissions of a series is not possible, and therefore the mounted bevel gear transmissions may perfectly well have different running properties and service lives. Furthermore, it is necessary to employ specialized labor with as much experience as possible for the mounting of bevel gear transmissions which is universally carried out in the way described.

The object on which the present invention is based is to design a bevel gear transmission of the type initially mentioned, in such a way that, while design stability is preserved, a simplification and improved reproducibility of mounting are achieved.

To achieve this object, according to the invention, a bevel gear transmission of the type initially mentioned is characterized in that the transmission housing has fastened to it a fastening part which is produced separately from the bearing housing and which has an internal thread to which an external thread of the bearing housing can be screwed, in that the relative angular position between the fastening part of the bearing housing can be fixed, and in that, in the mounted state, the bearing housing projects with a cylindrical extension, in a fit, into the respective passage orifice of the transmission housing, said passage orifice being designed as a guide.

In the bevel gear transmission according to the invention, the axial adjustment of the position of the bevel wheel is possible in that the position of the bearing housing supporting the bevel wheel can be varied in relation to the transmission housing by the bearing housing being rotated in the thread with respect to the fastening part fixed to the transmission housing. The affords the appreciable advantage that the adjustment of the axial position of the bevel wheel takes place after the fastening of the fastening part to the transmission housing has taken place, so that, no variation in position occurs any longer as a result of this fastening after adjustment. In order to avoid design instabilities which could arise if the fastening of the bearing housing were to take place solely via the threaded connection with the fastening part, there is provision, according to the invention, in the mounted state, for the bearing housing to project with a cylindrical extension, in a fit, into the passage orifice and thus be additionally guided by the passage orifice of the transmission housing over the thickness of the wall in which the passage orifice is located. This results in a highly accurate and stable angular and positional positioning of the axis of rotation of the bevel wheel, along with the likewise highly accurate and reproducible adjustability of the axial position of the bevel wheel.

In a preferred embodiment of the invention, the fastening part is designed as a flanged ring. The bearing housing may expediently have a cylindrical shape.

The fixing of the angular position between the flanged ring and the bearing housing may take place in a simple way in that a screw can be screwed into a radial threaded hole of the flanged ring and thus fixes the flanged ring in relation to the bearing housing by clamping. Alternative fixings of the angular position are obtained by adhesive bonding, locking with a lock nut or the like.

The invention will be explained in more detail below with reference to an exemplary embodiment illustrated in the drawing in which:

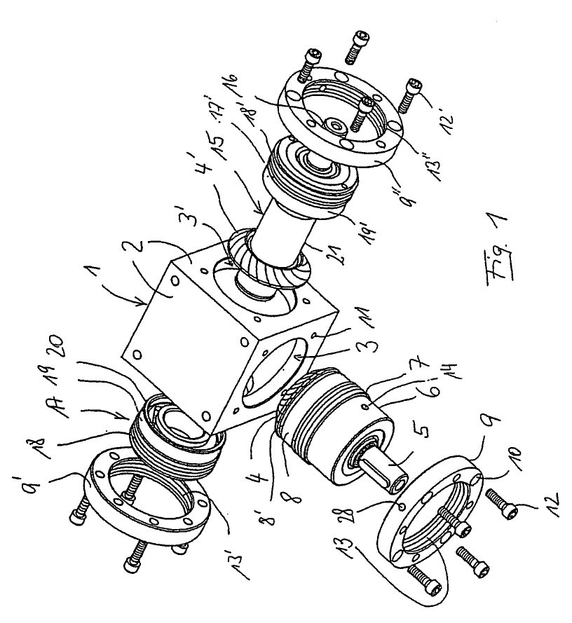

FIG. 1 shows a diagrammatic exploded illustration of the parts of a bevel gear transmission,

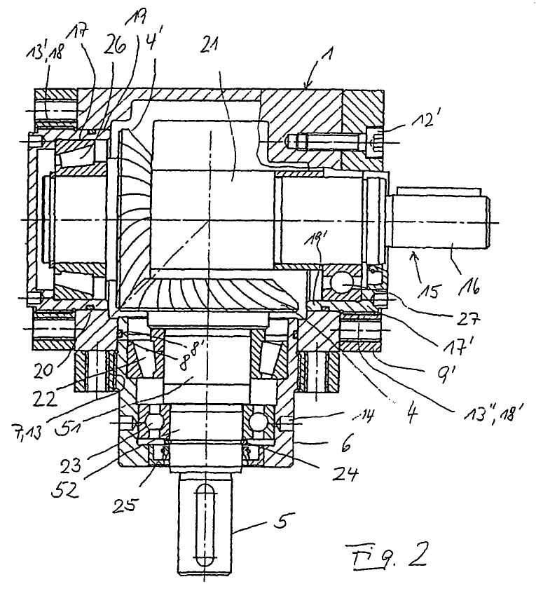

FIG. 2 shows a sectional illustration of the mounted bevel gear transmission according to FIG. 1.

FIG. 1 discloses a cuboid transmission housing 1 with six side walls 2.

In the exemplary embodiment illustrated, three side walls 3 have passage orifices 3, 3′. Two of the passage orifices 3, 3′ are in alignment with one another and are therefore located in mutually opposite side walls 2 of the transmission housing 1. The other passage orifice 3 is located in a wall 2 of the transmission housing 1 which is adjacent to the two mutually opposite side walls 2 having the passage orifices 3′.

A bevel wheel 4 with a shaft 5 connected to it belongs to the passage orifice 3. The bevel wheel 4 can project through the passage orifice 3 into the interior wall of the transmission housing 1 and mesh there with a bevel wheel 4′, the axis of rotation of which is perpendicular to the axis of rotation of the bevel wheel 4. The bevel wheel 4 is mounted with its shaft 5 in a cylindrical bearing housing 6 which has on its outer face a threaded portion 7 projecting somewhat radially. The threaded portion 7 has an outside diameter which is larger than the diameter of the passage orifice 3. A cylindrical extension 8 of the bearing housing is located between the threaded portion 7 and the bevel wheel 4, the outside diameter of said extension corresponding to the inside diameter of the passage orifice 3. Introduced into a peripheral groove of the extension 8 is an O-ring 8′, by means of which a sealing off of the passage orifice 3 is effected.

For fastening the bearing housing 6 to the transmission housing 1, there serves a fastening part 9 which is designed as a flanged ring and which is provided with passage bores 10 which are in alignment with threaded blind bores 11 in that wall 2 of the transmission housing 1 which has the passage orifice 3, so that the flanged ring 9 can be screwed to the transmission housing 1 by means of conventional screws 12. The flanged ring 9 has an internal thread 13 which is designed for receiving the external thread on the threaded portion 7 of the bearing housing 6. To rotate the bearing housing 6 in the internal thread 13 of the flanged ring 9 by means of a tool, two mutually opposite blind bores 14, into which a suitable hook wrench can engage, are located on the bearing housing 6. Alternatively, the blind bores 14 may also be replaced, for example, by faces for an open-end wrench or the like.

The second bevel wheel 4′ is located on a shaft 15 which has a driven end 16 projecting out of the transmission housing 1. The other end of the shaft 15 is mounted in a bearing part 17 which is provided in a similar way to the bearing housing 6 with a threaded portion 18 and with a cylindrical extension 19 having an O-ring 20. The bearing part 17 is fastened to the transmission housing 1 in the same way as the bearing housing 6 by means of a flanged ring 9′ which is likewise provided with an internal thread 13′.

On the other side of the bevel wheel 4′, a cylindrical portion 21 of the shaft 15, the length of which portion corresponds approximately to the width of the bevel wheel 4′, has adjoining it a bearing part 17′ which is designed in the same way with a threaded portion 18′ and with a cylindrical extension 19′. Fastening takes place by means of a flanged ring 9″, provided with an internal thread 13″, via screws 12′.

FIG. 2 illustrates the mounted state in a sectional illustration. It can be seen, in this case, that the shaft 5 belonging to the bevel wheel 4 is mounted with two stepped portions 51, 52 in the bearing housing 6, specifically, in the embodiment illustrated, the portion 51 by means of a tapered roller bearing 22 and the portion 52 by means of a ball bearing 53. The axial securing of the shaft 5 in the bearing housing 6 takes place by means of a spring ring 24 engaging into a groove. The shaft 5 is sealed off with respect to the axial exit of the bearing housing 6 by means of a sealing arrangement 25.

That end of the shaft 15 which is, mounted in the bearing part 17 is mounted by means of a tapered roller bearing 26, while the shaft 15 is mounted in the bearing part 17′ by means of a ball bearing 27.

It can be seen that the axial position of the bevel wheel 4 can be set by means of the threaded connections 7, 13 as a result of the rotation of the bearing housing 6. Rotation takes place, after the flanged ring 9 has been screwed firmly to the transmission housing 1, when appropriate, by means of a tool engaging into the blind bores 14. After the axial position has been adjusted, the relative position between the bearing housing 6 and annular flange 9 is fixed, in that, for example, a grub screw is screwed into a radially continuous threaded bore 28 of the flanged ring 9 (FIG. 1) and presses in a clamping manner against the outer face of the bearing housing 6.

The axial position of the bevel wheel 4′ can be set in the same way by means of the threaded connection 13″, 18′. By means of the threaded connection 13″, 18, only the axial position of the bearing part 17 can be set, but this is normally not critical.

It can be seen that the axial positions of the bevel wheels 4, 4′ meshing with their toothings can be set accurately and reproducibly via the threaded connections 7, 13 and 13″, 18′. By the extensions 8, 19′ being guided in the respective passage orifice 3, 3′, the design stability in terms of the angular and positional accuracy of the axes of rotation of the bevel wheels 4, 4′ is ensured.

1. A Bevel gear transmission with a transmission housing (1), the walls (2) of which are provided with at least two passage orifices (3, 3′) for at least two bevel wheels (4, 4′) which engage with their toothings one in the other inside the transmission housing (1) and at least one of which has a shaft (5) which is mounted rotatably in a bearing (22, 23) of a bearing housing (6) and which projects out of the transmission housing (1) through the passage orifice (3), the bearing housing (6) being fastened to the transmission housing (1), characterized in that the transmission housing (1) has fastened to it a fastening part (9) which is produced separately from the bearing housing (6) and which has an internal thread (13), to which an external thread of the bearing housing (6) can be screwed, in that the relative angular position between the fastening part (9) and the bearing housing (6) can be fixed, and in that, in the mounted state, the bearing housing (6) projects with a cylindrical extension (8), in a fit, into the respective passage orifice (3) of the transmission housing (1), said passage orifice being designed as a guide.

2. The bevel gear transmission as claimed in claim 1, characterized in that the fastening part (9) is designed as a flanged ring.

3. The bevel gear transmission as claimed in claim 2, characterized in that, to fix the angular position between the flanged ring (9) and the bearing housing (6), a screw can be screwed into a radial threaded hole (28) of the flanged ring (9).

4. The bevel gear transmission as claimed in claim 1, characterized in that the bearing housing (6) is fastened to the outer face of the transmission housing (1).
